(19) United States
(12) Patent Application Publication
(10) Pub. No.: US 2021/0035019 A1
(43) Pub. Date: Feb. 4, 2021

(54) METHOD, SYSTEM AND DEVICE FOR DISTRIBUTED EDGE AI TRAINING

(71) Applicant: ANTS TECHNOLOGY (HK) LIMITED, Hong Kong (HK)

(72) Inventors: Ron Fridental, Shoham (IL); Pavel Nosko, Yavne (IL); Alex Rosen, Ramat-Gan (IL)

(21) Appl. No.: 16/774,006

(22) Filed: Jan. 28, 2020

Related U.S. Application Data
(60) Provisional application No. 62/881,387, filed on Aug. 1, 2019.

(51) Int. Cl. G06N 20/00; G06N 5/04

(52) U.S. Cl. CPC G06N 20/00; G06N 5/04

(57) ABSTRACT

A method for AI training at an end device placed in an end-user premises, the method comprising: receiving by a processor of the end device sensor data captured by a sensor bundle of the end device; deciding if the sensor data included a data unit that requires external feedback, and in case external feedback is required obtaining external feedback about classification of the data unit; updating a decision module controlled by the processor of the end device based on the obtained feedback; and making a decision about the received sensor data, by the decision module. The external feedback is obtained from an end user or from another device. The method includes obtaining instructions about the type of decision to make, from a user or by pre-configuration. External feedback about the decision is obtained and the decision module is updated based on the feedback.

### BACKGROUND

Known detection and sensing devices sometimes include pre-configured and/or pre-trained artificial intelligence (AI) modules such as neural networks (ANN) and/or other machine learning (ML) module, software and/or hardware, trained to make a certain kind of decisions. Usually, an ANN or ML module is trained by receiving as input labeled and/or unlabeled data examples and altering weights and/or parameters of the network until the decisions of the network are sufficiently accurate.

For example, an ANN and/or ML module may be pre-trained, for example based on examples of image sensor data, to detect whether a person enters a room where an image sensor is installed. Once the training is finished, for example the weights and/or parameters of the network are determined, identical ANNs and/or ML modules are installed in end devices which may be marketed to various end users.

### SUMMARY

An aspect of some embodiments of the present disclosure provides a method for artificial intelligence training at an end device placed in an end-user premises, the method comprising: receiving by a processor of the end device sensor data captured by a sensor bundle of the end device; deciding if the sensor data included a data unit that requires external feedback, and in case external feedback is required obtaining external feedback about classification of the data unit; updating a decision module controlled by the processor of the end device based on the obtained feedback; and making a decision about the received sensor data, by the decision module.

Optionally, the external feedback is obtained from an end user or from another device.

Optionally, the method includes obtaining instructions about the type of decision to make, from a user by a communication interface of the end device or by pre-training.

Optionally, the method includes obtaining external feedback about the decision and updating the decision module based on the obtained feedback.

Optionally, the external feedback is obtained from an end user or from another device.

Optionally, the method includes receiving data examples uploaded to device by an end user or another device, and updating the decision module based on the uploaded examples.

Optionally the uploaded examples are labeled data examples.

Optionally, the method includes receiving from another device an update component for updating the decision module based on a configuration of a decision module of the other device, and updating the decision module by the received update component.

Optionally, the method includes generating and sharing with another device an update component resulting from updating of the decision module.

Optionally, the update component includes an updated portion of an artificial neural network or a machine learning module.

Optionally, the method includes requesting from another device an update component that matches a certain profile.

Optionally, the method includes receiving an indication that an update component with a certain profile has been generated or been made available for uploading.

Optionally, the method includes uploading and installing an update component in the decision module by an end user via a communication interface.

Optionally, the method includes validating the update component by the processor by checking that the update component adds to a current configuration of the decision module.

Optionally, the method includes validating the update component by the processor by implementing the update component in the decision module, making a decision by the decision module, receiving an external feedback about the decision made after the implementation and deciding whether or not to keep the update component based on the feedback.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a system for artificial intelligence training at an end device, according to some embodiments of the present disclosure;

FIG. 2 is a schematic flowchart illustrating a method for artificial intelligence training at an end device, according to some embodiments of the present disclosure; and

FIG. 3 is a schematic flowchart illustrating a method for artificial intelligence training at an end device by network updates, according to some embodiments of the present disclosure.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

As described above, known AI-based devices are configured and/or trained in the manufacturing process and marketed as-is. Usually, known devices cannot be further configured and/or trained after manufacturing or by software update. Therefore, for example, they are required to detect and/or make decisions based on various examples that are not specific to an end user premises. For example, a device may be required to detect whether a person enters a room based on training examples that refer to other kinds of rooms and person appearances. Known devices cannot be adapted to specific needs and/or environments of end users.

However, some embodiments of the present invention provide a device, system and method that enable end-device AI configuration and/or training, for example by involving an end user in the training process.

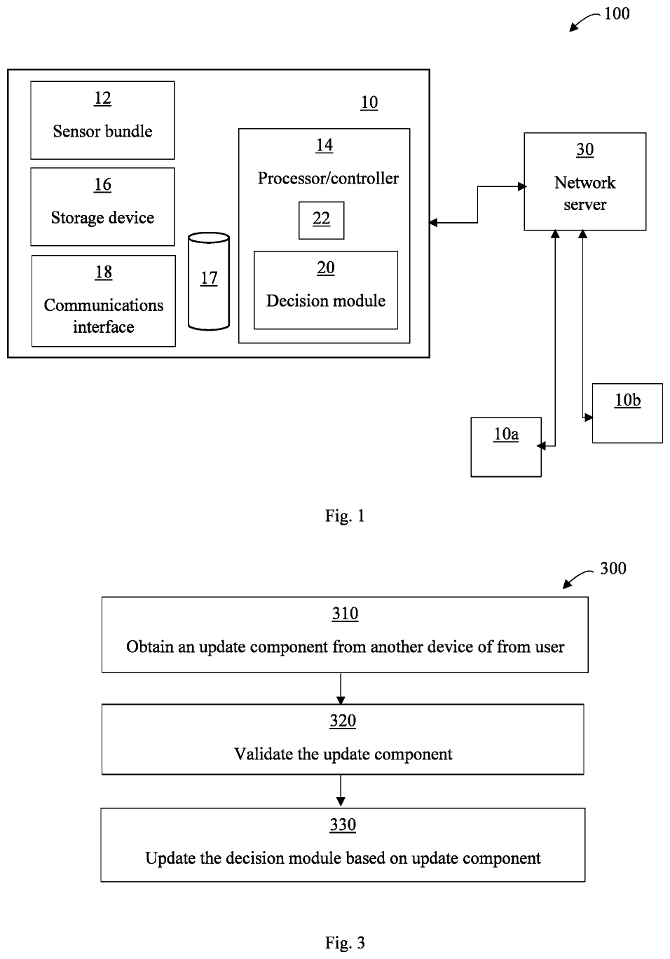

Reference is now made to FIG. 1, which is a schematic illustration of a system 100 for AI training at an end device 10, according to some embodiments of the present disclosure. System 100 may include an end device 10. End device 10 may be installed at private and/or proprietary premises of an end user, also called herein “end user premises”. The end user may be an individual or a group of individuals that have permission to operate, configure and/or provide instructions to end device 10. For example, family members that live in a house where device 10 and/or sensor bundle 12 is installed, or a group of employees that work in an office where device 10 and/or sensor bundle 12 is installed.

Device 10 may include at least a sensor bundle 12, at least one hardware processor/controller 14, at least one hardware storage medium 16, a database 17, for example as part of storage medium 16, and/or a communication interface 18. Sensor bundle 12 may be and/or include at least one sensor such as an image sensor, a light sensor, a sound sensor, an infrared sensor, a motion sensor, a pressure sensor, and/or any other suitable sensor. Sensor bundle 12 may or may not be included in the same housing, container and/or packaging as other components of device 10.

Processor/controller 14 may include at least one decision module 20 and at least one controller 22. Processor/controller 14 may include, control and or communicate with decision module 20, storage medium 16, database 17, sensor bundle 12 and/or communication interface 18, for example to execute the methods described herein, according to instructions stored in storage medium 16. For example, storage medium 16 is a non-transitory memory storing code instructions executable by processor 14. When executed, the code instructions cause processor 14 to carry out the methods as described in detail herein. Processor 14 may execute, run and/or control a decision module 20. According to some embodiments of the present disclosure, decision module 20 is configured to classify data and/or to detect certain states, and/or any other suitable target task. In some embodiments, decision module 20 is configured to be trained to perform and/or enhance performance of the classifying, detecting, and/or another suitable task. For example, decision module 20 includes machine training and/or artificial intelligence capabilities, such as artificial neural networks.

System 100 may further include at least one remote server 30 that may communicate with device 10 and with other remote devices, databases and/or computing resources, such as but not limited to remote devices 10a, 10b.

According to some embodiments of the present invention, decision module 20 may include an initial AI configured with initial weights and/or parameters to classify, detect and/or perform other tasks with data received from sensor bundle 12.

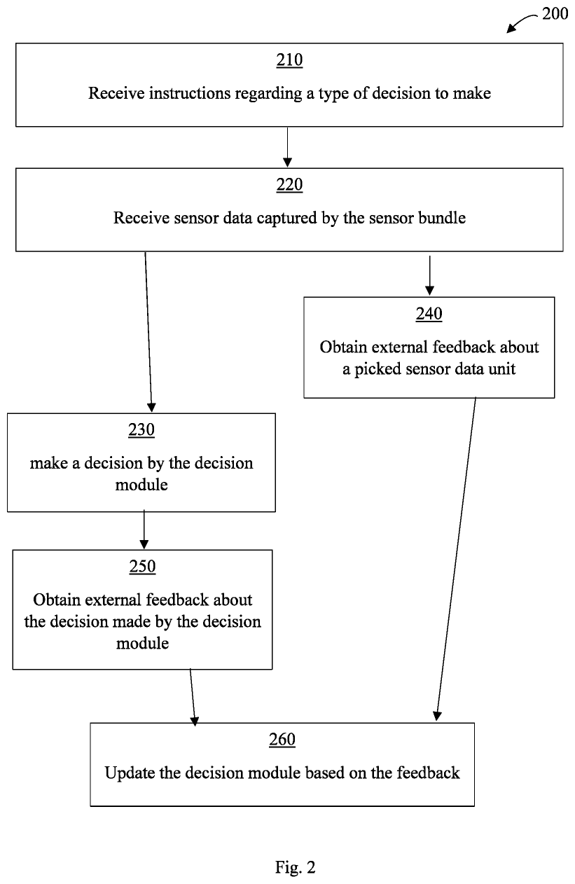

Reference is now made to FIG. 2, which is a schematic flowchart illustrating a method 200 for AI training at an end device 10, according to some embodiments of the present disclosure. Method 200 may be performed after end device 10 and/or sensor bundle 12 is installed and/or placed in an end-user premises. As indicated in block 210, processor 14 may receive instructions, for example from an end user, regarding a type of decision to make. For example, device 10 may be instructed to recognize a certain face, a certain type of object, certain sounds, a certain state or situation, and/or any other suitable kind of decision. In some embodiments of the present disclosure, the type of decision to make is preconfigured and/or not received from an end user. As indicated in block 220, processor 14 may receive sensor data captured by sensor bundle 12. In some embodiments, processor 14 may also receive data examples uploaded to device 10 by an end user and/or by server 30, for example via communication interface 18. The captured and/or uploaded sensor data may be stored at database 17. In some embodiments, the uploaded data examples are labeled data examples, the labels may indicate the desired classifications of the examples, and decision module 20 may be updated based on the uploaded examples and/or their labels.

As indicated in block 230, processor 14 may make a decision by decision module 20. It will be appreciated that making a decision means inputting the sensor data into decision module 20 and calculating by decision module 20 whether the sensor data implies and/or belongs to a certain class and/or state. More specifically, for example, decision module 20 may calculate the probability that certain sensor data implies and/or belongs to a certain class and/or state, and classify the data to a certain state and/or class in case the probability is above a certain threshold. According to some embodiments, decision module 20 includes an ANN and/or ML module that may receive the sensor data as input and classify the sensor data, for example, as belonging or not belonging to a certain class. Class means, for example, a certain state, identity and/or object identified with a probability above a defined threshold in the sensor data.

As indicated in block 240, processor 14 may request and/or receive feedback, for example from an end user and/or from server 30, about a data example, for example a certain picked sensor data unit. For example, processor 14 may request indication about whether or not a certain data unit constitute relevant data, for example, data of interest for making a certain decision or whether or not the data unit should be classified to a certain class. For example, processor 14 may request feedback during, before or after a decision process. For example, processor 14 may send a message to an end user and/or server 30 via communication interface 18. For example, from time to time, processor may pick a data unit and/or inquire an end user and/or server 30 about relevancy of the picked data unit. In some embodiments, processor 14 may request an end user and/or server 30 to label a certain data unit, and/or receive from an end user and/or server 30 labeling of a certain data unit, as belonging or not belonging to a certain class. For example, processor 14 may pick the data unit randomly and/or based on a determined criterion and/or after an indecisive decision process regarding this data unit. For example, the criterion may include an indication that the data unit may have increased effect on training of decision module 20. For example, in case the data sample is suspected as including more and/or different information than other sensor data samples, it may be recognized as having potential to contribute to training of decision module 20 and/or that training based on this data unit may make the future decision making by module 20 more accurate, and, thus for example, this data unit may be picked by processor 14.

In some embodiments of the present invention, processor 14 may send certain elements of data units to server 30, for example without sending the full data sample, for example in order to refrain from privacy breaches, for example to refrain from sending and/or showing private information outside the end-user premises. For example, processor 14 may send to server 30 data signature and/or certain data parameters and/or characteristics of the data unit, which may enable server 30 to make decision about the data unit without processing the full data unit. For example, processor 14 may send to server 30 a data vector representing and/or characterizing the data unit. For example, the data vector may incorporate values, parameters, gradients, weights and/or average values that characterize the data unit and may enable server 30 to make a decision about the data unit.

As indicated in block 250, processor 14 may request and/or receive feedback, for example from an end user and/or from server 30 about the decision that was made. For example, processor 14 may receive a feedback from an end user about whether or not the decision was accurate and/or conforms with needs and/or requirements of the end user. In some embodiments, server 30 may check the decision with other devices, for example request other devices to make the decision based on the same data and/or data elements and see if the decision made by device 10 matches the decisions made by other devices.

As indicated in block 260, processor 14 may update decision module 20 based on the feedback received about data units and/or about the decision that was made. For example, the updating may include training and/or re-training and/or adjustment of an ANN and/or ML module, and/or alteration of weights and/or parameters of decision module 20, for example to make more accurate future decisions and/or decisions that better conform to needs and/or requirements of an end user and/or to the end-user environment.

In some embodiments of the present disclosure, based on the feedback received about data units and/or about the decision that was made, processor 14 may control sensor bundle 12, for example by controller 22, to alter its configuration and/or orientation, for example in order to receive more accurate and/or relevant sensor data.

As indicated herein, according to some embodiments of the present disclosure, system 100 may include a network of other AI-based devices, such as, for example, devices 10a and 10b. Devices 10a and 10b may be able to communicate with device 10 directly and/or indirectly, for example by server 30. Devices 10a and/or 10b may each include its own decision module that may have its own profile and configuration. For example, each of devices 10, 10a and/or 10b may train and/or configure its respective decision module 20 based on sensor data units relevant to and/or obtained from its corresponding end-user premises, for example by a respective sensor bundle 12. For example, each of devices 10, 10a and/or 10b may have its own profile including, for example, a geographic location, the type of decisions it is trained to make, type of end-user premises in which the device and/or sensor bundle is installed, type(s) of sensor(s) included in its sensor bundle, and/or any other suitable profile parameters.

In some embodiments of the present disclosure, device 10 may share with and/or receive from the other devices in system 100 decision module update components. The update components received from other devices may enable device 10 to update decision module 20 based on trainings and/or configurations of decision modules of the other devices, thus, for example, improving the decision making of module 20. Similarly, device 10 may generate and/or share with other devices update components resulting from training and/or updating its decision module 20. The generated update components may enable the other devices to improve the decision making of their respective decision modules. The update components may include updated ANN and/or ML module portions, that may be implemented in the decision module of the receiving device. An update component may have a profile including, for example, a geographic location, the type of decisions it is trained to make, type of end-user premises in which the respective device and/or sensor bundle is installed, type(s) of sensor(s) included in its sensor bundle, and/or any other suitable profile parameters. For example, the profile of the update component is inherited from the device that generated the update component.

Reference is now made to FIG. 3, which is a schematic flowchart illustrating a method 300 for AI training at an end device 10 by network updates, according to some embodiments of the present disclosure. As indicated in block 310, device 10 may obtain from server 30 and/or device 10a and/or device 10b an update component. For example, device 10 may request from server 30 and/or devices 10a and/or 10b an update component that matches a certain profile. For example, device 10 may receive an indication from server 30 and/or devices 10a and/or 10b that an update component with a certain profile has been generated and/or made available for sharing and/or uploading. In some embodiments, an end user may provide an indication to processor 14 that an update component with a certain profile has been generated and/or made available for sharing and/or uploading. In some embodiments, an end user may upload an update component to and/or install an update component in decision module 20, for example by interface 18.

As indicated in block 320, device 10 may validate the update component. For example, device 10 may make sure that the update component improves the decision making of module 20. For example, device 10 may check that the update component is different from and/or adds and/or alters significant elements to a current decision-making process and/or a current ANN and/or ML module configuration. For example, device 10 may implement the update component in module 20, receive feedback about a decision made after the implementation, and decide whether or not to keep the update component based on the feedback. As indicated in block 330, device 10 may update module 20 according to the received update component. In some embodiments of the present disclosure, for example after updating decision module 20, processor 14 may further train decision module 20, for example as described with reference to FIG. 2, for example in order to adapt the update to the end user requirements and/or to the environment where device 10 and/or sensor bundle 12 are positioned.

In some embodiments of the present invention, after validating the update component, for example after receiving feedback about a decision made by module 20 with the update component implemented therein, and/or deciding whether or not to keep the update component, processor 14 may communicate the results of the validation and/or the decision made to other devices of the network such as devices 10a and 10b and/or to network server 30. Based on the validation results and/or decisions made with respect to the update component by various devices in the network, other devices may make decisions whether to implement and/or keep the update component.

Some embodiments of the present disclosure may include a system (hardware and/or software), a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, or a FPGA, or a GPU, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for AI training at an end device placed in an end-user premises, the method comprising:
receiving by a processor of the end device sensor data captured by a sensor bundle of the end device;
deciding if the sensor data included a data unit that requires external feedback, and in case external feedback is required obtaining external feedback about classification of the data unit;
updating a decision module controlled by the processor of the end device based on the obtained feedback; and
making a decision about the received sensor data, by the decision module.

2. The method of claim 1, wherein the external feedback is obtained from an end user or from another device.

3. The method of claim 1, comprising obtaining instructions about the type of decision to make, from a user by a communication interface of the end device or by pre-configuration.

4. The method of claim 1, comprising obtaining external feedback about the decision and updating the decision module based on the obtained feedback.

5. The method of claim 4, wherein the external feedback is obtained from an end user or from another device.

6. The method of claim 1, comprising receiving data examples uploaded to device by an end user or another device, and updating the decision module based on the uploaded examples.

7. The method of claim 6, wherein the uploaded examples are labeled data examples.

8. The method of claim 1, comprising receiving from another device an update component for updating the decision module based on a configuration of a decision module of the other device, and updating the decision module by the received update component.

9. The method of claim 8, comprising generating and sharing with another device an update component resulting from updating of the decision module.

10. The method of claim 8, wherein the update component includes an updated portion of an artificial neural network or a machine learning module.

11. The method of claim 8, comprising requesting from another device an update component that matches a certain profile.

12. The method of claim 8, comprising receiving an indication that an update component with a certain profile has been generated or been made available for uploading.

13. The method of claim 8, comprising uploading and installing an update component in the decision module by an end user vie a communication interface.

14. The method of claim 8, comprising validating the update component by the processor by checking that the update component adds to a current configuration of the decision module.

14. The method of claim 8, comprising validating the update component by the processor by implementing the update component in the decision module, making a decision by the decision module, receiving an external feedback about the decision made after the implementation and deciding whether or not to keep the update component based on the feedback.
